(19) United States
(12) Patent Application Publication
(10) Pub. No.: US 2023/0121691 A1
(43) Pub. Date: Apr. 20, 2023

(54) COVER BODY ASSEMBLY OF BATTERY AND BATTERY

(71) Applicant: Xiamen Hithium Energy Storage Technology Co., Ltd., Xiamen (CN)

(72) Inventors: Weidong XU, Xiamen (CN); Nan ZHANG, Xiamen (CN); Yang TANG, Xiamen (CN); Ziqi YI, Xiamen (CN); Zuyu WU, Xiamen (CN)

(73) Assignee: Xiamen Hithium Energy Storage Technology Co., Ltd., Xiamen (CN)

(21) Appl. No.: 17/956,166

(22) Filed: Sep. 29, 2022

(30) Foreign Application Priority Data
Oct. 18, 2021 (CN) 202122506875.7

(51) Int. Cl. H01M 50/15; H01M 50/143; H01M 50/627

(52) U.S. Cl. CPC H01M 50/15; H01M 50/143; H01M 50/627

(57) ABSTRACT

The present disclosure discloses a cover body assembly of a battery and a battery. The battery includes a housing provided with an opening; a cover body assembly used for closing the opening; and a jelly-roll arranged inside an inner cavity of the housing; a liquid injection channel is arranged on the cover body assembly; electrolyte is injected into the inner cavity of the housing through the liquid injection channel, thus soaking the jelly-roll; the cover body assembly includes a cover body; and a lower insulation plate which is connected to a bottom surface of the cover body and is disposed at an interval, thus forming a distribution channel between the lower insulation plate and the cover body; and the distribution channel is communicated to the liquid injection channel and the inner cavity of the housing.

### CROSS REFERENCE TO RELATED APPLICATION

The application claims priority to and benefits of Chinese patent application CN202122506875.7, filed on Oct. 18, 2021, which is incorporated herein by reference in its entireties.

### FIELD

The present disclosure relates to the field of batteries, and in particular to a cover body assembly of a battery and a battery.

### BACKGROUND

With the vigorous development of the new energy industry, as the protagonist of the new energy industry, a battery has also been vigorously developed.

Normally, a battery includes a cover body assembly, a jelly-roll and a housing. The jelly-roll is arranged in an inner cavity of the housing, and the cover body assembly is covered at an opening of the housing. The cover body assembly is provided with a liquid injection channel, and electrolyte can be injected into the inner cavity of the housing through the liquid injection channel, so that the jelly-roll is soaked in the electrolyte.

However, in the process of injecting the electrolyte into the inner cavity of the housing through the liquid injection channel, the electrolyte often stays in the cover body assembly, so that the electrolyte cannot all reach the jelly-roll, causing waste of the electrolyte.

### SUMMARY

The present disclosure discloses a cover body assembly of a battery and a battery, which can effectively avoid the phenomenon that electrolyte stays in the distribution channel.

To achieve the above purpose, an embodiment of the present disclosure provides a cover body assembly of a battery including a housing provided with an opening; a cover body assembly used for closing the opening; and a jelly-roll arranged inside an inner cavity of the housing; the cover body assembly being provided with a liquid injection channel; electrolyte being injected into the inner cavity of the housing through the liquid injection channel, such that the jelly-roll is soaked; the cover body assembly including a cover body; and a lower insulation plate which is connected to a bottom surface of the cover body and is disposed at an interval, thus forming a distribution channel between the lower insulation plate and the cover body, the distribution channel being communicated to the liquid injection channel and the inner cavity of the housing.

In one embodiment, the lower insulation plate is provided with a first liquid injection hole penetrating the lower insulation plate along a thickness direction of the lower insulation plate; the cover body is provided with a second liquid injection hole which penetrates the cover body along a thickness direction of the cover body and corresponds to the first liquid injection hole; and the first liquid injection hole and the second liquid injection hole are communicated to each other to form the liquid injection channel.

In one embodiment, a first gap is formed between the lower insulation plate and the cover body; and the first gap is the distribution channel.

In one embodiment, when the cover body assembly covers the opening of the housing, a second gap is formed between at least part of a side wall of the lower insulation plate and the inner surface of the housing; and the second gap is communicated to the distribution channel and the inner cavity of the housing.

In one embodiment, the lower insulation plate is rectangular; two side walls of the lower insulation plate extending along a length direction contact the inner surface of the housing; and the second gap is formed between at least one of the two side walls of the lower insulation plate extending along a width direction and the inner surface of the housing.

In one embodiment, the lower insulation plate is further provided with: an explosion-proof hole which penetrates the lower insulation plate; and an explosion-proof net which is arranged at the explosion-proof hole and is provided with a drainage hole, the drainage hole being communicated to the distribution channel.

In one embodiment, the explosion-proof net includes a middle section and two side sections connected to two ends of the middle section; a distance between the middle section and an upper surface of the lower insulation plate is less than a distance between the two side sections and the upper surface; and the drainage hole is arranged at the two side sections.

In one embodiment, a protrusion is arranged on a lower surface of the lower insulation plate; recesses are formed on an upper surface of the lower insulation plate; projections of the recesses on the lower surface are located within a projection of the protrusion on the lower surface; bottoms of the recesses are provided with circulating holes; the circulating holes penetrate the bottoms of the recesses; and the circulating holes are communicated to the distribution channel.

In one embodiment, an area of a projection of the bottom of each recess on the lower surface is larger than that of a projection of each circulating hole on the lower surface.

In one embodiment, the area of the projection of the circulating hole on the lower surface is S1, and the area of the projection of the recess on the lower surface is S2, ¼≤S1/S2≤⅓.

In one embodiment, a depth of the recess in a direction perpendicular to the lower surface is 5.5 mm to 7 mm.

In one embodiment, the lower insulation plate is rectangular; the protrusion includes a first convex strip and a second convex strip; the first convex strip is disposed along a first edge of the lower insulation plate; the second convex strip is disposed along a second edge of the lower insulation plate; the first edge and the second edge are opposite; and the first liquid injection hole is located between the first convex strip and the second convex strip.

In one embodiment, the lower insulation plate is rectangular; the first edge and the second edge are two edges of the lower insulation plate extending along the width direction; and a length of the first convex strip and a length of the second convex strip are both equal to the width of the lower insulation plate.

In one embodiment, the recesses include a plurality of first recesses and a plurality of second recesses; the plurality of first recesses are disposed in a manner of corresponding to the position of the first convex strip; the first recesses are arranged at intervals along a length direction of the first convex strip; the bottom of each first recess is provided with the circulating hole; the plurality of second recesses are disposed in a manner of corresponding to the position of the second convex strip; and the bottom of each second recess is provided with the circulating hole.

In one embodiment, an opening of the first recess and an opening of the second recess are both rectangular; one edge of the opening of the first recess is parallel to the first edge; one edge of the opening of the second recess is parallel to the second edge; and widths of the first recess and the second recess along an extending direction of the first edge are both 6 mm to 9 mm.

An embodiment of the present disclosure also provides a battery including the cover body assembly according to any one of above embodiments.

Compared with the prior art, the present disclosure has the following beneficial effects: the lower insulation plate is connected to the bottom surface of the cover body and is disposed at an interval, so that the distribution channel can be formed between the lower insulation plate and the cover body. In addition, the distribution channel is communicated to the liquid injection channel, so that when the electrolyte is injected to the jelly-roll through the liquid injection channel, part of the electrolyte may possibly enter the distribution channel. Next, the distribution channel is communicated to the inner cavity of the housing, so that after the electrolyte enters the distribution channel, the electrolyte can continue to flow into the inner cavity of the housing. In this way, the phenomenon that electrolyte stays in the distribution channel can be avoided. That is, the phenomenon that the electrolyte stays in the cover body assembly.

### BRIEF DESCRIPTION OF THE DRAWINGS

FIG. 1 is a schematic structural diagram of a battery provided by an embodiment of the present disclosure;

FIG. 2 is an exploded diagram of the battery in FIG. 1;

FIG. 3 is a schematic structural diagram of a cover body assembly of a battery provided by an embodiment of the present disclosure;

FIG. 4 is a partially enlarged diagram of position A in FIG. 3;

FIG. 5 is an exploded diagram of a cover body and a lower insulation plate provided in an embodiment of the present disclosure;

FIG. 6 is a sectional view (no section line is shown) of the battery in FIG. 1 along the X axis;

FIG. 7 is a partially enlarged diagram of position B in FIG. 6;

FIG. 8 is a schematic structural diagram of the lower insulation plate in FIG. 5 under another visual angle; and

FIG. 9 is a schematic structural diagram of the lower insulation plate in FIG. 8 under another visual angle.

### DETAILED DESCRIPTION OF EMBODIMENTS

### Embodiment I

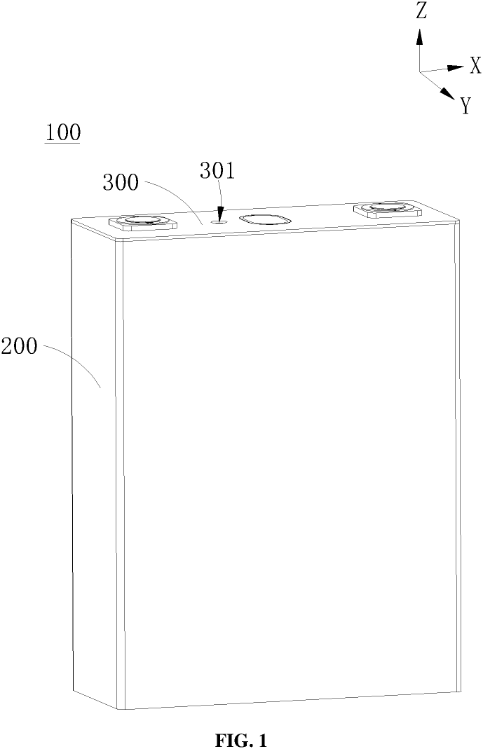

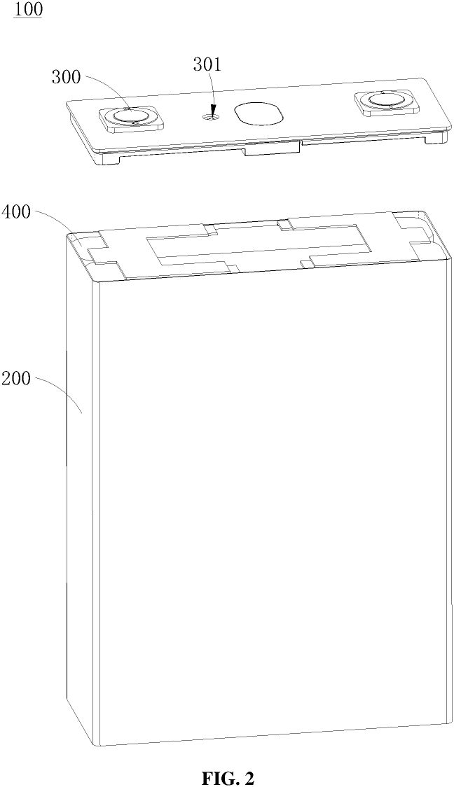

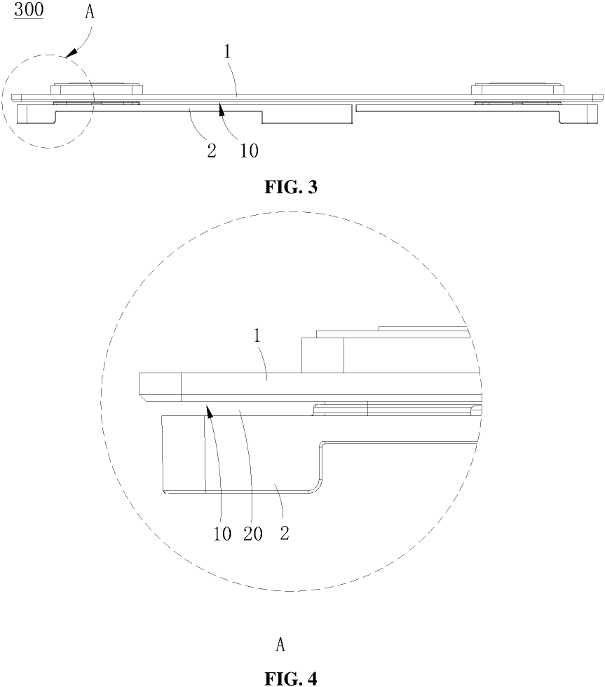

FIG. 1 is a schematic structural diagram of a battery provided by an embodiment of the present disclosure; FIG. 2 is an exploded diagram of the battery in FIG. 1; and FIG. 3 is a schematic structural diagram of a cover body assembly of a battery provided by an embodiment of the present disclosure.

Referring to FIG. 1 and FIG. 2, the battery 100 includes a housing 200 provided with an opening; a cover body assembly 300 used for closing the opening; and a jelly-roll 400 arranged in an inner cavity of the housing 200. the cover body assembly 300 is provided with a liquid injection channel, and electrolyte is injected into the inner cavity of the housing 200 through the liquid injection channel 301, such that the jelly-roll 400 is soaked. In this way, after the electrolyte soaks the jelly-roll 400, a series of effects can be achieved to cause the battery to realize a power supply function or an electric energy storage function.

However, in the process of injecting the electrolyte into the inner cavity of the housing 200 through the liquid injection channel 301, part of the electrolyte may possibly stay in the cover body assembly 300. As a result, part of the electrolyte does not reach the jelly-roll 400.

Based on this, the present disclosure provides a cover body assembly 300. For example, referring to FIG. 2, FIG. 3 and FIG. 4, the cover body assembly 300 includes: a cover body 1 and a lower insulation plate 2. The lower insulation plate 2 is connected to a bottom surface of the cover body 1 and is disposed at an interval, thus forming a distribution channel 10 between the lower insulation plate 2 and the cover body 1. The distribution channel 10 is communicated to the liquid injection channel 301 and the inner cavity of the housing 200.

In the embodiment of the present disclosure, the lower insulation plate 2 is connected to the bottom surface of the cover body 1 and is disposed at an interval, so that the distribution channel 10 can be formed between the lower insulation plate 2 and the cover body 1. In addition, the distribution channel 10 is communicated to the liquid injection channel 301, so that when the electrolyte is injected to the jelly-roll 400 through the liquid injection channel 301, part of the electrolyte may possibly enter the distribution channel 10. Next, the distribution channel 10 is communicated to the inner cavity of the housing 200, so that after the electrolyte enters the distribution channel 10, the electrolyte can continue to flow into the inner cavity of the housing 200. In this way, the phenomenon that electrolyte stays in the distribution channel 10 can be avoided. That is, the phenomenon that the electrolyte stays in the cover body assembly 300.

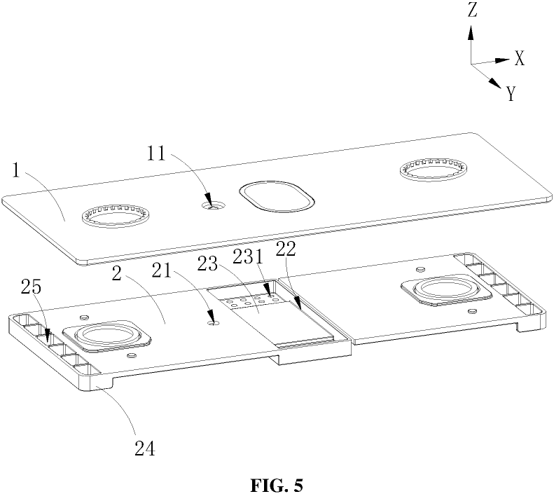

In some embodiments, referring to FIG. 5, the lower insulation plate 2 is provided with a first liquid injection hole 21 which penetrates the lower insulation plate 2 along a thickness direction of the lower insulation plate 2. The cover body 1 is provided with a second liquid injection hole 11 which penetrates the cover body 1 along a thickness direction of the cover body 1 and corresponds to the first liquid injection hole 21. The first liquid injection hole 21 and the second liquid injection hole 11 are communicated with each other to form the liquid injection channel 301.

The first liquid injection hole 21 is formed in the lower insulation plate 2, and the second liquid injection hole 11 corresponding to the first liquid injection hole 21 is formed in the cover body 1; and the first liquid injection hole 21 and the second liquid injection hole 11 are communicated with each other to form the liquid injection channel 301. During injection of electrolyte, the electrolyte can reach the jelly-roll 400 through the second liquid injection hole 11 and the first liquid injection hole 21. In this way, the purpose of injecting electrolyte to the jelly-roll 400 through the second liquid injection hole 11 and the first liquid injection hole 21 can b achieved.

The way of forming the liquid injection channel 301 by communicating the first liquid injection hole 21 to the second liquid injection hole 11 is extremely simple, so that the structural complexity of the cover body assembly 300 can be reduced to a certain extent.

In some embodiments, referring to FIG. 4, a first gap 20 is formed between the lower insulation plate 2 and the cover body 1. The first gap 20 is a distribution channel 10.

The first gap 20 is formed between the lower insulation plate 2 and the cover body 1, and the first gap 20 is used as the distribution channel 10. The way of forming the distribution channel 10 is extremely simple. Therefore, the structural complexity of the cover body assembly 300 can be reduced to a certain extent, and the manufacturing cost of the cover body assembly 300 can be reduced to a certain extent.

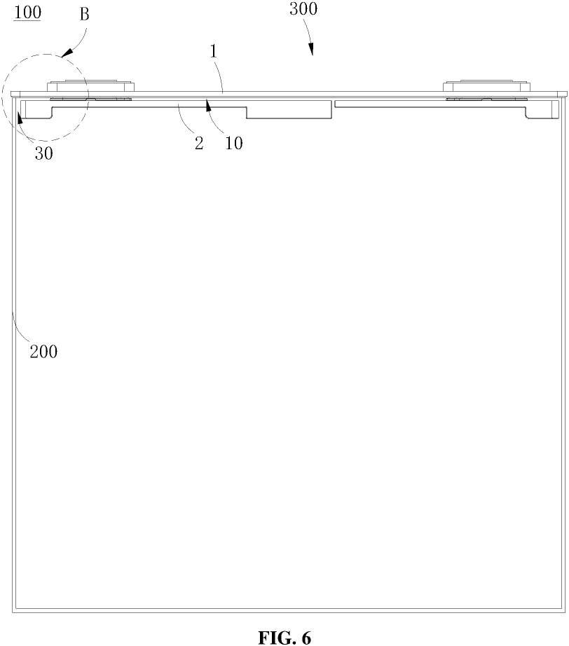

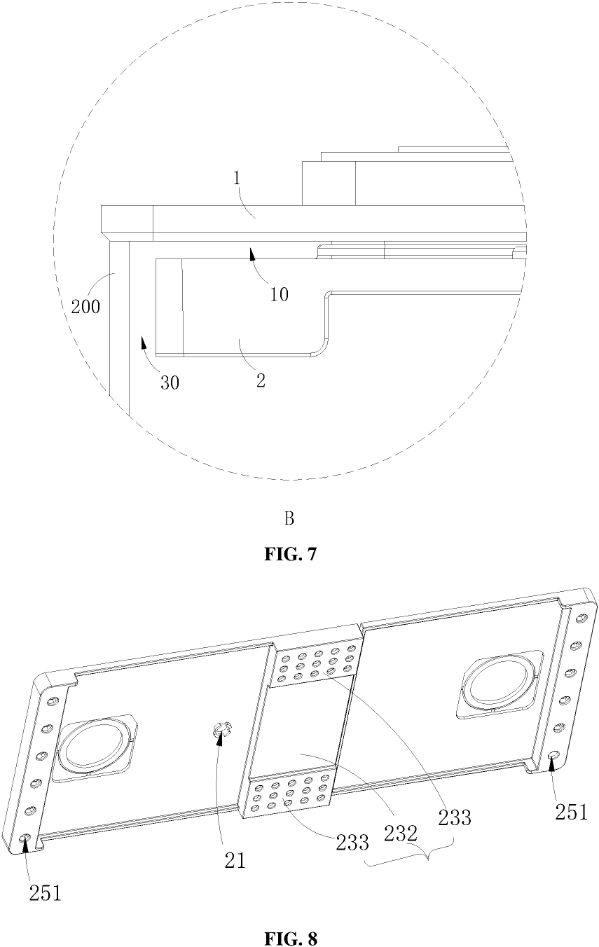

In some embodiments, referring to FIG. 6 and FIG. 7, when the cover body assembly 300 covers the opening of the housing 200, a second gap 30 is formed between at least part of a side wall of the lower insulation plate 2 and an inner surface of the housing 200. The second gap 30 is communicated to the distribution channel 10 and the inner cavity of the housing 200.

When the second gap 30 is formed between at least part of the side wall of the lower insulation plate 2 and the inner surface of the housing 200, the distribution channel 10 will be communicated to the inner cavity of the housing 200 through the second gap 30. In this way, the electrolyte in the distribution channel 10 can reach, through the second gap 30, the jelly-roll 400 located in the inner cavity of the housing 200.

When the second gap 30 is formed between at least part of the side wall of the lower insulation plate 2 and the inner surface of the housing 200, it can be understood that the second gap 30 is closer to the inner surface of the housing 200. In this way, the electrolyte can reach a periphery of the jelly-roll 400, so that the electrolyte reaching the jelly-roll 400 via the second gap 30 is arranged more uniformly.

Further, referring to FIG. 6 and FIG. 7, the lower insulation plate 2 is rectangular; two side walls of the lower insulation plate 2 extending along a length direction contact the inner surface of the housing 200; and the second gap 30 is formed between at least one of two side walls of the lower insulation plate 2 extending along a width direction and the inner surface of the housing 200. The two side walls of the lower insulation plate 2 along the length direction are longer than the two side walls along the width direction, so that the two side walls of the lower insulation plate 2 along the length direction are connected to the inner surface of the housing 200 to make more stable connection between the lower insulation plate 2 and the housing 200. The positions of the jelly-roll 400 close to the two side walls of the lower insulation plate 2 along the width direction are farther from the middle part of the jelly-roll 400, less electrolyte may possibly reach the positions of the jelly-roll 400. The second gap 30 is formed between at least one of the two side walls of the lower insulation plate 2 along the width direction and the inner surface of the housing 200, so that the electrolyte entering via the second gap 30 can just reach the positions of the jelly-roll 400 close to the two side walls of the lower insulation plate 2 along the width direction. Therefore, the phenomenon that less electrolyte may possibly reach the positions of the jelly-roll 400 close to the two side walls of the lower insulation plate 2 along the width direction can be avoided.

In some embodiments, referring to FIG. 5, the lower insulation plate 2 is also provided with an explosion-proof hole 22 and an explosion-proof net 23. The explosion-proof hole 22 penetrates the lower insulation plate 2. The explosion-proof net 23 is arranged at the explosion-proof hole 22. The explosion-proof net 23 is provided with a drainage hole 231 which is communicated to the distribution channel 10.

The explosion-proof hole 22 penetrates the lower insulation plate 2; the explosion-proof net 23 is arranged at the explosion-proof hole 22; and the explosion-proof net 23 is provided with the drainage hole 231. Therefore, the drainage hole 231 can penetrate through the lower insulation plate 2. Based on this, the distribution channel 10 can be communicated to the inner cavity of the housing 200 through the drainage hole 231. In this way, the electrolyte in the distribution channel 10 can also flow into the inner cavity of the housing 200 through the drainage hole 231.

It should be noted that the explosion-proof hole 22 may be rectangular or of any possible shapes. The embodiment of the present disclosure does not limit this. The number of the drainage hole 231 may be one, two, three, four or five. The embodiment of the present disclosure does not limit the number of the drainage hole 231 either.

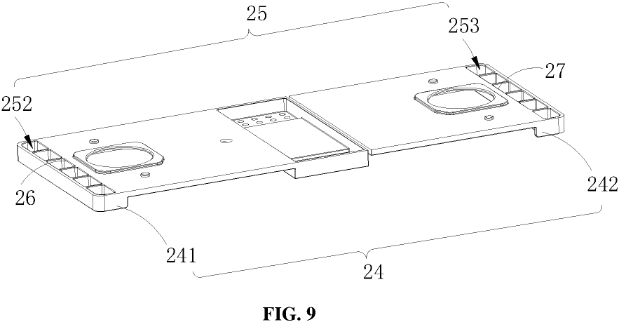

Further, in some embodiments, referring to FIG. 8, the explosion-proof net 23 includes a middle section 232 and two side sections 233 connected to two ends of the middle section 232; a distance between the middle section 232 and an upper surface of the lower insulation plate 2 is less than a distance between the two side sections 233 and the upper surface of the lower insulation plate 2; and the drainage holes 231 are arranged on the two side sections 233.

The distance between the middle section 232 and the upper surface of the lower insulation plate 2 is less than the distance between the two side sections 233 and the upper surface of the lower insulation plate 2, so that the two side sections 233 are closer to the inner cavity of the housing 200. The drainage holes 231 are formed in the two side sections 233, so that the drainage holes 231 on the two side sections 233 can form a microcirculation with the electrolyte in the distribution channel 10 and in the inner cavity of the housing 200. The electrolyte is in more uniform contact with the jelly-roll 400.

In some embodiments, referring to FIG. 5 and FIG. 8, a protrusion 24 is arranged on a lower surface of the lower insulation plate 2; recesses 25 are formed on the upper surface of the lower insulation plate 2; and projections of the recesses 25 on the lower surface are located within a projection of the protrusion 24 on the lower surface. bottoms of the recesses 25 are provided with circulating holes 251; the circulating holes 251 penetrate the bottoms of the recesses; and the circulating holes 251 are communicated to the distribution channel 10.

In the embodiment of the present disclosure, when the electrolyte in the distribution channel 10 is unable to reach a side where the jelly-roll 400 is located through the liquid injection channel 301 due to various reasons, the electrolyte will stay on the upper surface of the lower insulation plate 2. As a result, the electrolyte is wasted or the upper surface of the lower insulation plate 2 is corroded to be damaged by the electrolyte.

The recesses 25 are arranged on the upper surface of the lower insulation plate 2, so that the electrolyte staying on the upper surface of the lower insulation plate 2 can flow into the recesses 25. After the electrolyte reaches the recesses 25, since there are circulating holes 251 that are arranged at the bottoms of the recesses 25 and penetrate to the lower surface, the electrolyte in the recesses 25 can reach a side where the lower surface of the lower insulation plate 2 is located through the circulating holes 251. In this way, the phenomenon that the electrolyte stays on the upper surface of the lower insulation plate 2 for a long time can be avoided, so that the phenomenon that the electrolyte is wasted or the upper surface of the lower insulation plate 2 is corroded to be damaged by the electrolyte can be avoided.

The protrusion 24 is arranged on the lower surface of the lower insulation plate 2; the recesses 25 are arranged on the upper surface; and the projections of the recesses 25 on the lower surface are located within the projection of the protrusion 24 on the lower surface. Therefore, the recesses 25 can always extend along a direction close to the protrusion 24 to the protrusion 24. In this way, the recesses 25 can be deeper. Generally, the recesses 25 may have a larger volume. In this way, when there is much electrolyte on the side where the upper surface of the lower insulation plate 2 is located, a lot of electrolyte can all enter the recesses 25, so that the phenomenon that the electrolyte stays on the upper surface of the lower insulation plate 2 for a long time can be avoided.

It can be seen that by the arrangement of the protrusion 24 and the recesses 25, the projections of the recesses 25 on the lower surface are located within the projection of the protrusion 24 on the lower surface. On the one hand, the volume of the recesses 25 is large; and on the other hand, other positions of the lower insulation plate 2 except for the position provided with the protrusion 24 are still thinner, and the structural design is very ingenious.

In some embodiments, referring to FIG. 5 and FIG. 8, an area of a projection of the bottom of each recess 25 on the lower surface is larger than that of a projection of each circulating hole 251 on the lower surface. Since the area of the projection of the bottom of each recess 25 on the lower surface is larger than that of the projection of each circulating hole 251 on the lower surface, the recess 25 has a function of temporarily storing electrolyte. For example, when there is much electrolyte on the side where the upper surface of the lower insulation plate 2 is located, since the area of the projection of the bottom of each recess 25 on the lower surface is larger than that of the projection of each circulating hole 251 on the lower surface, a lot of electrolyte can be all temporarily stored in the recesses 25 at first and then slowly flows to the side where the lower surface of the lower insulation plate 2 is located through the circulating hole 251 arranged at the bottom of the recess 25. Therefore, the following phenomenon can be avoided: in the process that the electrolyte flows from the side where the upper surface of the lower insulation plate 2 is located to the side where the lower surface of the lower insulation plate 2 is located, since the circulating hole 251 is small, the flow speed is low, causing the electrolyte to stay on the upper surface of the lower insulation plate 2 for a long time.

In some embodiments, referring to FIG. 5 and FIG. 8, the area of the projection of each circulating hole 251 on the lower surface is S1, and the area of the projection of each recess 25 on the lower surface is S2, ¼≤S1/S2≤⅓. The inventor has found via studies that when the area of the projection of each circulating hole 251 on the lower surface is S1, and the area of the projection of each recess 25 on the lower surface is S2, ¼≤S1/S2≤⅓, on the one hand, the size of the circulating hole 251 can ensure that the electrolyte temporarily stored in the recess 25 can successfully flow to the side where the lower surface of the lower insulation plate 2 is located through the circulating hole 251; and on the other hand, the following phenomenon can also be avoided: since the circulating hole 251 is too small, the electrolyte cannot timely flow to the side where the lower surface of the lower insulation plate 2 is located through the circulating hole 251, and the electrolyte temporarily stored in the recess 25 overflows out of the recess 25.

For example, S1/S2 may be ¼, 7/24 or ⅓, as long as S1/S2 is located within ¼ to ⅓. The embodiment of the present disclosure does not enumerate the numerical values of S1/S2.

In some embodiments, referring to FIG. 5, a depth of the above-mentioned recess 25 in a direction perpendicular to the lower surface (i.e., the Z-axis direction in FIG. 5) is 5.5 mm to 7 mm. The inventor has found via studies that when the depth of the recess 25 in the direction perpendicular to the lower surface is 5.5 mm to 7 mm, on the one hand, the volume of the recess 25 may be large to play a role of temporarily storing electrolyte; and on the other hand, the following phenomenon can be avoided: if the depth of the recess 25 in the direction perpendicular to the lower surface is too large, the height of the protrusion 24 in the direction perpendicular to the lower surface is too large, which causes the entire lower insulation plate to be too thick.

Of course, the depth of the recess 25 in the direction perpendicular to the lower surface can also be other numerical values. For example, in some embodiments, the depth of the recess 25 in the direction perpendicular to the lower surface may also be 6 mm, 6.5 mm and the like. The embodiment of the present disclosure does not limit this.

In some embodiments, referring to FIG. 9, the lower insulation plate 2 is rectangular. The protrusion 24 includes a first convex strip 241 and a second convex strip 242; the first convex strip 241 is disposed along a first edge 26 of the lower insulation plate; the second convex strip 242 is disposed along a second edge 27 of the lower insulation plate; the first edge 26 and the second edge 27 are opposite; and the first liquid injection hole 21 is located between the first convex strip 241 and the second convex strip 242. It can be understood that when the first convex strip 241 and the second convex strip 242 are arranged on the lower insulation plate, the first convex strip 241 and the second convex strip 242 can play a role of enhancing the strength of the lower insulation plate. Based on this, the first convex strip 241 is disposed along the first edge 26 of the lower insulation plate, and the second convex strip 242 is disposed along the second edge 27 of the lower insulation plate, and the first edge 26 and the second edge 27 are two opposite edges of the rectangular lower insulation plate. Therefore, the first convex strip 241 and the second convex strip 242 can enhance the strength of the lower insulation plate on the two opposite edges of the lower insulation plate, and the enhancement effect is better.

In addition, side walls of the first convex strip 241 and the second convex strip 242 close to the housing 200 can also be used to be connected to the housing 200, so that the connection between the lower insulation plate 2 and the housing 200 is more stable.

The first liquid injection hole 21 is arranged between the first convex strip 241 and the second convex strip 242, so that the electrolyte near the first liquid injection hole 21 can flow into the recesses 25 on the first convex strip 241 or flow into the recesses 25 on the second convex strip 242, or simultaneously flow into the recesses 25 on both the first convex strip 241 and the second convex strip 242. Therefore, the phenomenon that electrolyte stays on the upper surface of the lower insulation plate 2 for a long time can be better avoided.

In some embodiments, referring to FIG. 9, the lower insulation plate 2 is rectangular. The first edge 26 and the second edge 27 are two edges of the lower insulation plate extending along the width direction. A length of the first convex strip 241 and a length of the second convex strip 242 are both equal to the width of the lower insulation plate 2. When the first edge 26 and the second edge 27 are the two edges of the lower insulation plate extending along the width direction, the first convex strip 241 and the second convex strip 242 are disposed along the two edges in the width direction of the lower insulation plate. In this way, the first convex strip 241 and the second convex strip 242 can better play a role of enhancing the strength of the lower insulation plate.

The length of the first convex strip 241 and the length of the second convex strip 242 are both equal to the width of the lower insulation plate 2, so that two ends of the first convex strip 241 are flush with two ends of the lower insulation plate 2 in the width direction, and two ends of the second convex strip 242 are flush with the two ends of the lower insulation plate 2 in the width direction. In this way, a better effect of enhancing the strength of the lower insulation plate can be achieved.

In some embodiments, referring to FIG. 9, the recesses 25 include a plurality of first recesses 252 and a plurality of second recesses 253; the plurality of first recesses 252 are disposed in a manner of corresponding to the position of the first convex strip 241; the first recesses 252 are arranged at intervals along a length direction of the first convex strip 241; and the bottom of each first recess 252 is provided with the circulating hole 251. The plurality of second recesses 253 are disposed in a manner of corresponding to the position of the second convex strip 242; the second recesses 253 are arranged at intervals along a length direction of the second convex strip 242; and the bottom of each second recess 253 is provided with the circulating hole 251.

The plurality of first recesses 252 are disposed in a manner of corresponding to the position of the first convex strip 241; the first recesses 252 are arranged at intervals along the length direction of the first convex strip 241; and the bottom of each first recess 252 is provided with the circulating hole 251. Therefore, the electrolyte at the various positions on the upper surface of the lower insulation plate 2 can quickly enter the first recesses 252 closest to the electrolyte, and the electrolyte on the upper surface of the lower insulation plate 2 can leave the upper surface of the lower insulation plate 2 more quickly.

Similarly, the plurality of second recesses 253 are disposed in a manner of corresponding to the position of the second convex strip 242; the second recesses 253 are arranged at intervals along the length direction of the second convex strip 242; and the bottom of each second recess 253 is provided with the circulating hole 251. Therefore, the electrolyte at the various positions on the upper surface of the lower insulation plate 2 can quickly enter the second recesses 253 closest to the electrolyte, and the electrolyte on the upper surface of the lower insulation plate 2 can leave the upper surface of the lower insulation plate 2 more quickly.

The number of the first recesses 252 may be 6, 7 or 8. The embodiment of the present disclosure does not limit this. The number of the second recesses 253 may be 6, 7 or 8. The embodiment of the present disclosure does not limit this.

In some embodiments, referring to FIG. 9, an opening of the first recess 252 and an opening of the second recess 253 are both rectangular; one edge of the opening of the first recess 252 is parallel to the first edge 26; one edge of the opening of the second recess 253 is parallel to the second edge 27; and widths of the first recess 252 and the second recess 253 along an extending direction of the first edge 26 are both 6 mm to 9 mm.

When the opening of the first recess 252 is rectangular, the machining is very convenient, so that the machining cost of the first recess 252 can be reduced to a certain extent. Similarly, when the opening of the second recess 253 is rectangular, the machining cost of the second recess 253 can be reduced to a certain extent.

The inventor has found via studies that the widths of the first recess 252 and the second recess 253 along the extending direction of the first edge 26 are both 6 mm to 9 mm, on the one hand, the volumes of the first recess 252 and the second recess 253 are large, which can play a better role of temporarily storing electrolyte; and on the other hand, the following phenomenon can be avoided: if the first recess 252 and second recess 253 in the extending direction of the first edge 26 are too wide, the strength of the lower insulation plate 2 at the positions of the first recess 252 and the second recess 253 is reduced.

Of course, in some other embodiments, the widths of the first recess 252 and the second recess 253 along the extending direction of the first edge 26 can be other numerical values. For example, the widths of the first recess 252 and the second recess 253 along the extending direction of the first edge 26 may be 8.5 mm or 9 mm. The embodiment of the present disclosure does not limit to this.

In some embodiments, referring to FIG. 8, the above circulating hole 251 is a round hole. When the circulating hole 251 is a round hole, the machining is convenient. Therefore, the machining cost of the circulating hole 251 can be reduced. Of course, the circulating hole 251 may also be of other shapes. For example, in some embodiments, the circulating hole 251 may also be a rectangular hole or other polygonal holes. The embodiment of the present disclosure does not limit this.

In conclusion, in the embodiment of the present disclosure, the lower insulation plate 2 is connected to the bottom surface of the cover body 1 and is disposed at an interval, so that the distribution channel 10 can be formed between the lower insulation plate 2 and the cover body 1. In addition, the distribution channel 10 is communicated to the liquid injection channel 301, so that when the electrolyte is injected to the jelly-roll 400 through the liquid injection channel 301, part of the electrolyte may possibly enter the distribution channel 10. Next, the distribution channel 10 is communicated to the inner cavity of the housing 200, so that after the electrolyte enters the distribution channel 10, the electrolyte can continue to flow into the inner cavity of the housing 200. In this way, the phenomenon that electrolyte stays in the distribution channel 10 can be avoided. That is, the phenomenon that the electrolyte stays in the cover body assembly 300.

### Embodiment II

The embodiment of the present disclosure further provides a battery. Referring to FIG. 1, the battery includes any cover body assembly 300 in the above embodiment I.

The cover body assembly 300 may have the same structure as that of any cover body assembly 300 in the above embodiment I, and the same or similar beneficial effects can be achieved, which may specifically refer to the description in the above embodiment I. The embodiment of the present disclosure does not limit this.

In the embodiment of the present disclosure, the cover body assembly 300 can avoid the phenomenon that electrolyte stays in the distribution channel 10, i.e., the phenomenon that electrolyte stays in the cover body assembly 300. Therefore, when the cover body assembly 300 is applied to the battery 100, the performance of the battery can be better.

What is claimed is:

1. A cover body assembly of a battery, wherein the battery comprises a housing provided with an opening; a cover body assembly used for closing the opening; and a jelly-roll arranged inside an inner cavity of the housing; the cover body assembly is provided with a liquid injection channel; electrolyte is injected into the inner cavity of the housing through the liquid injection channel, such that the jelly-roll is soaked; the cover body assembly comprises:
a cover body; and
a lower insulation plate which is connected to a bottom surface of the cover body and is disposed at an interval, thus forming a distribution channel between the lower insulation plate and the cover body, wherein the distribution channel is communicated to the liquid injection channel and the inner cavity of the housing.

2. The cover body assembly according to claim 1, wherein:
the lower insulation plate is provided with a first liquid injection hole penetrating the lower insulation plate along a thickness direction of the lower insulation plate;
the cover body is provided with a second liquid injection hole which penetrates the cover body along a thickness direction of the cover body and corresponds to the first liquid injection hole; and
the first liquid injection hole and the second liquid injection hole are communicated to each other to form the liquid injection channel.

3. The cover body assembly according to claim 1, wherein a first gap is formed between the lower insulation plate and the cover body; and the first gap is the distribution channel.

4. The cover body assembly according to claim 1, wherein when the cover body assembly covers the opening of the housing, a second gap is formed between at least part of a side wall of the lower insulation plate and the inner surface of the housing; and the second gap is communicated to the distribution channel and the inner cavity of the housing.

5. The cover body assembly according to claim 4, wherein the lower insulation plate is rectangular; two side walls of the lower insulation plate extending along a length direction contact the inner surface of the housing; and the second gap is formed between at least one of two side walls of the lower insulation plate extending along a width direction and the inner surface of the housing.

6. The cover body assembly according to claim 1, wherein the lower insulation plate is further provided with:
an explosion-proof hole which penetrates the lower insulation plate; and
an explosion-proof net which is arranged at the explosion-proof hole and is provided with a drainage hole, the drainage hole being communicated to the distribution channel.

7. The cover body assembly according to claim 6, wherein the explosion-proof net comprises a middle section and two side sections connected to two ends of the middle section; a distance between the middle section and an upper surface of the lower insulation plate is less than a distance between the two side sections and the upper surface; and the drainage hole is arranged at the two side sections.

8. The cover body assembly according to claim 2, wherein:
a protrusion is arranged on a lower surface of the lower insulation plate; recesses are formed on an upper surface of the lower insulation plate;
projections of the recesses on the lower surface are located within a projection of the protrusion on the lower surface;
bottoms of the recesses are provided with circulating holes;
the circulating holes penetrate the bottoms of the recesses; and
the circulating holes are communicated to the distribution channel.

9. The cover body assembly according to claim 8, wherein an area of a projection of the bottom of each recess on the lower surface is larger than that of a projection of each circulating hole on the lower surface.

10. The cover body assembly according to claim 9, wherein the area of the projection of the circulating hole on the lower surface is S1, and the area of the projection of the recess on the lower surface is S2, ¼≤S1/S2≤⅓.

11. The cover body assembly according to claim 8, wherein a depth of the recess in a direction perpendicular to the lower surface is 5.5 mm to 7 mm.

12. The cover body assembly according to claim 8, wherein:
the lower insulation plate is rectangular;
the protrusion comprises a first convex strip and a second convex strip;
the first convex strip is disposed along a first edge of the lower insulation plate;
the second convex strip is disposed along a second edge of the lower insulation plate;
the first edge and the second edge are opposite; and
the first liquid injection hole is located between the first convex strip and the second convex strip.

13. The cover body assembly according to claim 12, wherein:
the lower insulation plate is rectangular;
the first edge and the second edge are two edges of the lower insulation plate extending along the width direction; and
a length of the first convex strip and a length of the second convex strip are both equal to the width of the lower insulation plate.

14. The cover body assembly according to claim 12, wherein:
the recesses comprise a plurality of first recesses and a plurality of second recesses;
the plurality of first recesses are disposed in a manner of corresponding to the position of the first convex strip;
the first recesses are arranged at intervals along a length direction of the first convex strip;
the bottom of each first recess is provided with the circulating hole;
the plurality of second recesses are disposed in a manner of corresponding to the position of the second convex strip; and
the bottom of each second recess is provided with the circulating hole.

15. The cover body assembly according to claim 14, wherein:
an opening of the first recess and an opening of the second recess are both rectangular;
one edge of the opening of the first recess is parallel to the first edge;
one edge of the opening of the second recess is parallel to the second edge; and
widths of the first recess and the second recess along an extending direction of the first edge are both 6 mm to 9 mm.

16. A battery the battery comprising the cover body assembly according to claim 1.
